(19) United States
(12) Patent Application Publication
(10) Pub. No.: US 2009/0250120 A1
(43) Pub. Date: Oct. 8, 2009

(54) Fluid transfer systems and methods of forming fluid transfer systems

(76) Inventor: Tom E. Robbins, Spokane, WA (US)

Correspondence Address: WELLS ST. JOHN P.S., 601 W. FIRST AVENUE, SUITE 1300, SPOKANE, WA, 99201, US

(21) Appl. No.: 12/080,618

(22) Filed: Apr. 3, 2008

(51) Int. Cl. F16L 5/00

(52) U.S. Cl. 137/360

(57) ABSTRACT

A fluid transfer system includes a fluid regulator having a valve and a tube in fluid communication with the valve. A housing supports the fluid regulator and includes at least a partial enclosure. At least a portion of the fluid regulator is in the enclosure. The tube extends through a first surface of the housing. A flexible conduit is in fluid communication with the fluid regulator. The flexible conduit is compatible for connection with a fluid source.

### TECHNICAL FIELD

The invention pertains to fluid flow and/or transfer systems, and methods of forming fluid flow and/or transfer systems, inside and outside of buildings.

### BACKGROUND OF THE INVENTION

Fluid flow and/or transfer systems, such as showers, toilets and faucets, are routinely provided in structures such as buildings which include commercial buildings, factories, businesses, houses, homes and/or other type of dwellings. Exemplary fluid transfer systems include sinks, faucets and spouts provided in bathtubs/showers, storage or shed rooms, kitchens, utility or mud rooms and garages wherein the fluid source is water. When a structure is being built, contractors and/or plumbers provide an unfinished plumbing system in the wall of the room wherein coupling devices extend from the wall and are in fluid communication with the water source. Ultimately, components such as sinks, faucets, spouts, bathtubs/showers and cabinets are provided and connected to the coupling devices to provide water to the respective components. The configuration of the unfinished plumbing system, for a faucet and sink combination for example, is substantially the same traditional or routine configuration for all structures, albeit in compliance with local building codes.

However, customers are now demanding customized fluid flow systems which have developed a host of problems for the contractors and/or plumbers who put in the routine configuration of the unfinished plumbing system. For example, vessel sinks are custom sinks which rest on top of a cabinet (instead of being sunk into the cabinet surface) wherein a spout extends from the wall over the sink. This combination of the vessel sink and spout extending from a wall is not readily compatible with the routine configuration of the unfinished plumbing system.

Accordingly, there is a need to develop unfinished plumbing systems, and methods for implementing same, that allows for the incorporation of customized fluid transfer systems. Moreover, there is a need to develop fluid transfer systems that are interchangeable between being provided inside a building and being provided outside a building.

### BRIEF DESCRIPTION OF THE DRAWINGS

Preferred embodiments of the invention are described below with reference to the following accompanying drawings.

FIG. 1 is a perspective view of an exemplary bathroom to be modified with an exemplary fluid transfer system according to one of various methods of the invention and according to one of various fluid transfer systems of the invention.

FIG. 2 is a perspective view of an exemplary unfinished bathroom to be modified with a wall mount faucet design that includes a vessel sink.

FIG. 3 is a perspective view of the exemplary bathroom of FIG. 1 at a modification step subsequent to that shown in FIG. 1.

FIG. 4 is a rear, partial perspective view of a portion of the exemplary fluid transfer system of FIG. 1.

FIG. 5 is a front, partial perspective view of a portion of the exemplary fluid transfer system of FIG. 1.

FIG. 6 is a sectional view of a valve system for the exemplary fluid transfer system of FIG. 1.

FIG. 7 is a partial sectional and exploded view of a portion of the exemplary fluid transfer system of FIG. 1.

FIG. 8 is a perspective view of another one of various embodiments of an exemplary fluid transfer system according to the invention.

FIG. 9 is a perspective view of another one of various embodiments of an exemplary fluid transfer system according to the invention.

FIG. 10 is a perspective view of another exemplary bathroom to be modified with an exemplary fluid transfer system according to one of various methods of the invention and according to one of various fluid transfer systems of the invention.

FIG. 11 is a rear, partial perspective view of a portion of the exemplary fluid transfer system of FIG. 10.

FIG. 12 is a perspective view of another exemplary bathroom to be modified with an exemplary fluid transfer system according to one of various methods of the invention and according to one of various fluid transfer systems of the invention.

FIG. 13 is a perspective view of another exemplary bathroom to be modified with an exemplary fluid transfer system according to one of various methods of the invention and according to one of various fluid transfer systems of the invention.

FIG. 14 is a partial sectional view of another exemplary fluid transfer system according to one of various fluid transfer systems of the invention.

FIG. 15 is a rear perspective view of another exemplary fluid transfer system according to one of various fluid transfer systems of the invention.

FIG. 16 is a front perspective view of the exemplary fluid transfer system of FIG. 15.

FIG. 17 is another front perspective view of the exemplary fluid transfer system of FIG. 15.

FIG. 18 is a perspective view of forming an exemplary fluid transfer system according to one of various methods of the invention and according to one of various fluid transfer systems of the invention.

FIG. 19 is a perspective view of forming an exemplary fluid transfer system according to one of various methods of the invention and according to one of various fluid transfer systems of the invention.

FIG. 20 is a perspective view of forming an exemplary fluid transfer system according to one of various methods of the invention and according to one of various fluid transfer systems of the invention.

FIG. 21 is a perspective view of forming an exemplary fluid transfer system according to one of various methods of the invention and according to one of various fluid transfer systems of the invention.

### SUMMARY OF THE INVENTION

One aspect of the invention includes a fluid transfer system includes a fluid regulator having a valve and a tube in fluid communication with the valve. A housing supports the fluid regulator and includes at least a partial enclosure. At least a portion of the fluid regulator is in the enclosure. The tube extends through a first surface of the housing. A flexible conduit is in fluid communication with the fluid regulator. The flexible conduit is compatible for connection with a fluid source.

In another aspect of the invention, a method of forming a fluid transfer system in a building includes, at a location other than the site of the building, connecting a faucet to a housing structure. Transporting the housing structure with the faucet to the site of the building. Placing the faucet and housing structure in a space of the building. Connecting the faucet in fluid communication with a water source of the building.

### DETAILED DESCRIPTION OF THE PREFERRED EMBODIMENTS

This disclosure of the invention is submitted in furtherance of the constitutional purposes of the U.S. Patent Laws “to promote” the progress of science and useful arts” (Article 1, Section 8).

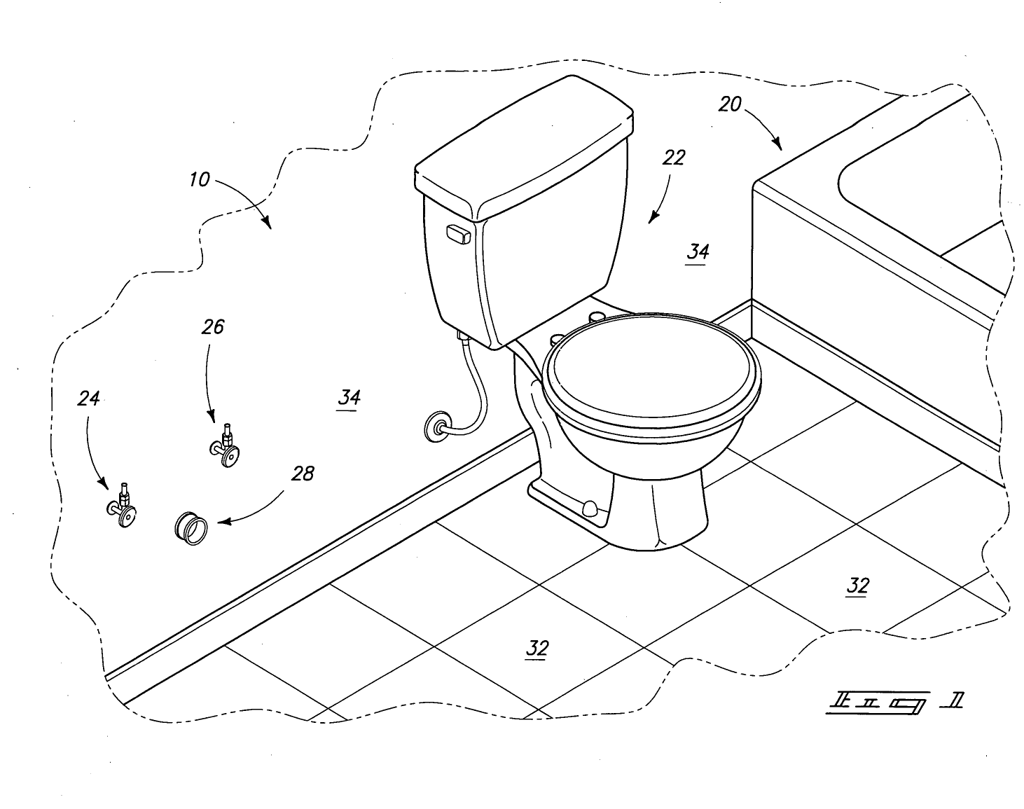

FIG. 1 illustrates a perspective view of an exemplary bathroom 10 to be modified according to one of various methods of the invention by implementing one of various inventive fluid transfer systems. Bathroom 10 can be provided for any type of building structure, whether public or private dwelling, including a home, business, manufacturing company or factory, and public or private mall. The exemplary bathroom 10 includes a bathtub 20 (and/or shower singularly or in combination) and a toilet 22 over a floor 32 and adjacent a wall 34. It should be understood that, either the bathtub 20 or toilet 22, or both, can be missing in any one of exemplary bathrooms 10.

Still referring to FIG. 1, the illustrated exemplary bathroom 10 includes supply valve 24, supply valve 26 and drain opening 28 extending from wall 34. Supply valves 24 and 26 are, or will be, provided in fluid communication with a fluid source of the building to the bathroom 10 wherein an exemplary fluid source is water. Drain opening or flange 28 is, or will be, provided in fluid communication with an evacuation conduit (not shown) that allows fluid to ultimately exit the building. It should be understood that each valve 24 and 26 can be oriented in any position relative the other, and each valve 24 and 26 can be oriented in any position relative the drain opening 28. Moreover, each valve 24 and 26 can be oriented in any position relative the floor 32, toilet 22 and/or bathtub 20. Furthermore, each valve 24 and 26 can be oriented in any position along wall 34, for example, more distant or proximate relative the floor 32, or more distant or proximate relative the toilet 22 and/or the bathtub 20. Still further, one or both valves 24 and 26 could extend from floor 32 instead of wall 34.

It should be understood that the illustrated FIG. 1 configuration of valves 24 and 26 and drain flange 28 is a routine or traditional configuration of an unfinished plumbing system for a bathroom. As stated previously, valves 24 and 26 are exemplary coupling devices which extend from the wall and are in fluid communication with the water source. Ultimately, components such as sinks, faucets and spouts are provided for the bathroom and connected to the valves 24 and 26 by the contractor and/or plumber to provide access to the water source through the spout to the sink. A cabinet or vanity, with or without a sink (and if provided, routinely a sunken sink), is provided against the wall over the valves 24 and 26 and drain flange 28. A countertop, with or without a sink (and if provided, routinely a sunken sink), is secured in the cabinet. The countertop and/or a portion of the sink if provided routinely include openings for faucet handles and spout. The faucet and sink combination is connected with the valves and drain flange, respectively, by conduits extending under the countertop in the cabinet. Accordingly, the FIG. 1 routine or traditional configuration of an unfinished plumbing system is provided in buildings for the plumber and/or contractor to subsequently connect with a faucet and sink combination for any room (bathroom, kitchen, any wash room such as utility or mud room, etc.) in a building.

The traditional unfinished plumbing system configuration (also referred to as the “supply valve configuration” or “shut off valve configuration”) of FIG. 1 streamlines the method of connecting a cabinet, sink and faucet system to the water source of the building. That is, the traditional unfinished plumbing system of FIG. 1 is a finished end of the water supply system of the building. Additionally, the exposed valves and drain flange provide an indication to the cabinet installer and plumber where the cabinet, sink and faucet system will be implemented in the room. Moreover, the supply valves keep the water flow turned off until access to the water supply is needed and allows the plumber to test the water supply for any leaks in the system once coupling to the sink and faucet is accomplished.

Additionally, the water supply can be immediately shut off if a problem develops during the connection of the faucet system with the water supply or in the faucet system itself wherein water may flow uncontrollably. Furthermore, future repairs or replacements of the faucet system can be implemented without shutting off the entire water supply to the building wherein only the water supply to the room would have to be shut off. Still further, the supply valves and the connecting conduits or hoses used to connect a faucet system to the water supply are all exposed inside a cabinet under the countertop. Accordingly, any leak that develops in these structures, even long after the building structure is completed, can be quickly detected so that the water supply can be immediately shut off to diminish and impede permanent water damage to the building.

However, for some custom bathrooms, retrofit bathrooms and remodel bathrooms, the configuration designs for supply valves are routinely different from the FIG. 1 configuration, for example, wall mount faucet configurations (discussed more thoroughly below). Logically, these configuration designs are not routine and implementing the custom design configurations require more skill, time and expenditure by the plumber and/or contractor. Moreover, the different design configurations negate the advantages discussed above of the FIG. 1 configurations which can be more readily understood by the following discussion of an example.

For example, recent requests by customers are for sinks designed or configured as basins, bowls (or vessel sinks) which are provided to set atop or rest generally on top of the countertop of a cabinet or vanity. An exemplary vessel sink can have an upper rim that is six to seven inches above the countertop. Therefore, a traditional spout which extends from the countertop does not have sufficient length to have the spout outlet height to extend over the height of an upper rim of the vessel sink. Accordingly, faucets systems designed to accommodate vessel sinks have the spout (and usually the handles) protruding or extending from an adjacent vertical wall at a height relative the vessel sink which is sufficient to accommodate the height of an upper rim of the vessel sink. With this design (referred to as a “wall mount faucet” design), the spout can be positioned as high as necessary on the vertical wall to accommodate servicing any rim height of a vessel sink.

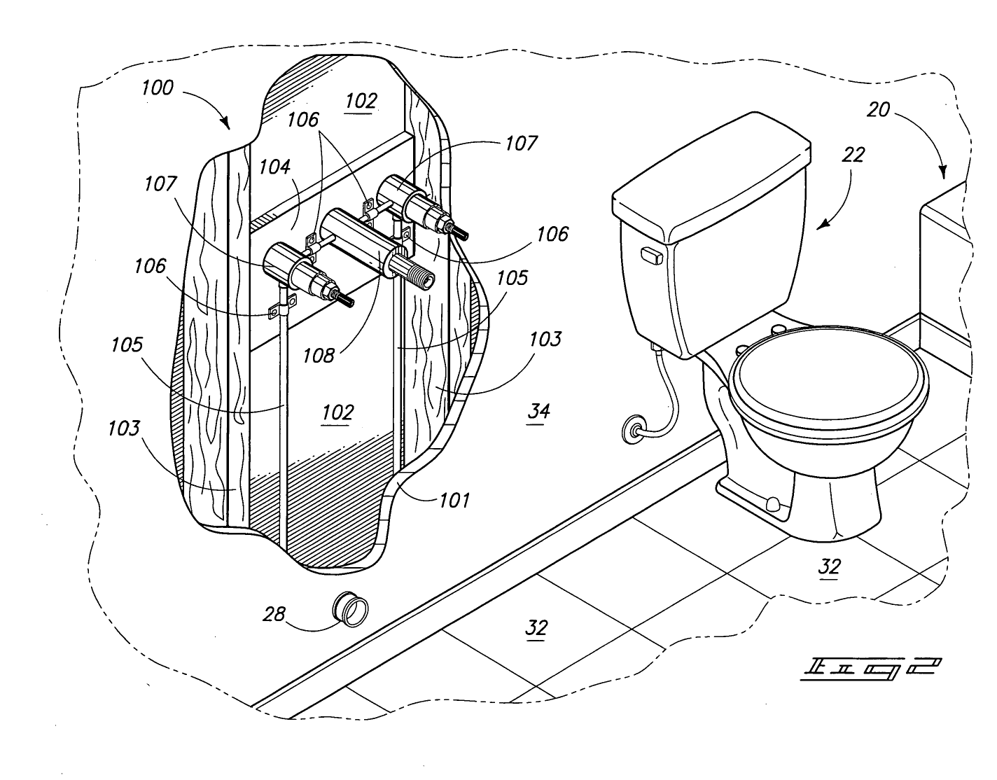

However, the wall mount faucet design requires a more skilled plumber to implement and has resulted in a modification to the traditional unfinished plumbing system configuration illustrated in FIG. 1. Referring to FIG. 2, an exemplary modification to the traditional unfinished plumbing system is illustrated (referred to as the “vessel unfinished plumbing system” 100) to accommodate the wall mount faucet design. It can be quickly discerned that this modification uses no supply valves or shut off valves which effectively negates the advantages listed above for the traditional unfinished plumbing system configuration. Moreover, fluid conduits 105 that provide water access to a subsequently-provided faucet system remain in the wall 34 of the room (as opposed to being located in the cabinet for ready access in the traditional unfinished plumbing system) as illustrated in the breakaway view 101 of wall 34 of FIG. 2. A support board 104 is secured between studs 103 which are secured between walls 102 and 34. Brackets or braces 106 secure fluid conduits 105 to support board 104. Nipples or spindles 107 extend through wall 34 to be subsequently fitted with faucet handles. Nipple or spindle 108 extends through wall 34 to be subsequently fitted with a spout. Nipples 107 and 108 replace the supply valves 24 and 26 of the traditional unfinished plumbing system illustrated in FIG. 1.

Accordingly, with the vessel unfinished plumbing system there is no readily accessible supply valves to keep the water flow turned off until access to the water supply is needed. Similarly, there are no readily accessible supply valves to keep the water flow turned off to allow the plumber to test the water supply for any leaks in the system. Additionally, the water supply cannot be immediately shut off if a problem develops during the connection of the faucet system with the water supply. Nor can the water supply be immediately shut off if a problem develops in the faucet system itself such as the fluid conduits 105 between walls 34 and 102 wherein water could flow uncontrollably. In fact, since the fluid conduits 105 are not exposed and accessible, any leak that develops in the fluid conduits 105 cannot be quickly detected to immediately shut off water and prevent water damage to the building. Furthermore, without supply valves to keep the water flow turned off, future repairs or replacements of the faucet system cannot be implemented without shutting off the entire water supply to the building.

Accordingly, there is a need to have a fluid transfer system which uses the traditional unfinished plumbing system and can accommodate custom faucets and sink, for example, vessel sink designs and wall mount faucet designs. Moreover, there is a need to have a fluid transfer system that is interchangeable with numerous different faucet designs and numerous different sink designs, for example, for retrofits and remodels. Furthermore, there is a need to have a fluid transfer system that can be used in any room of a building and can readily be removed from that room to be used in another room or outside the building.

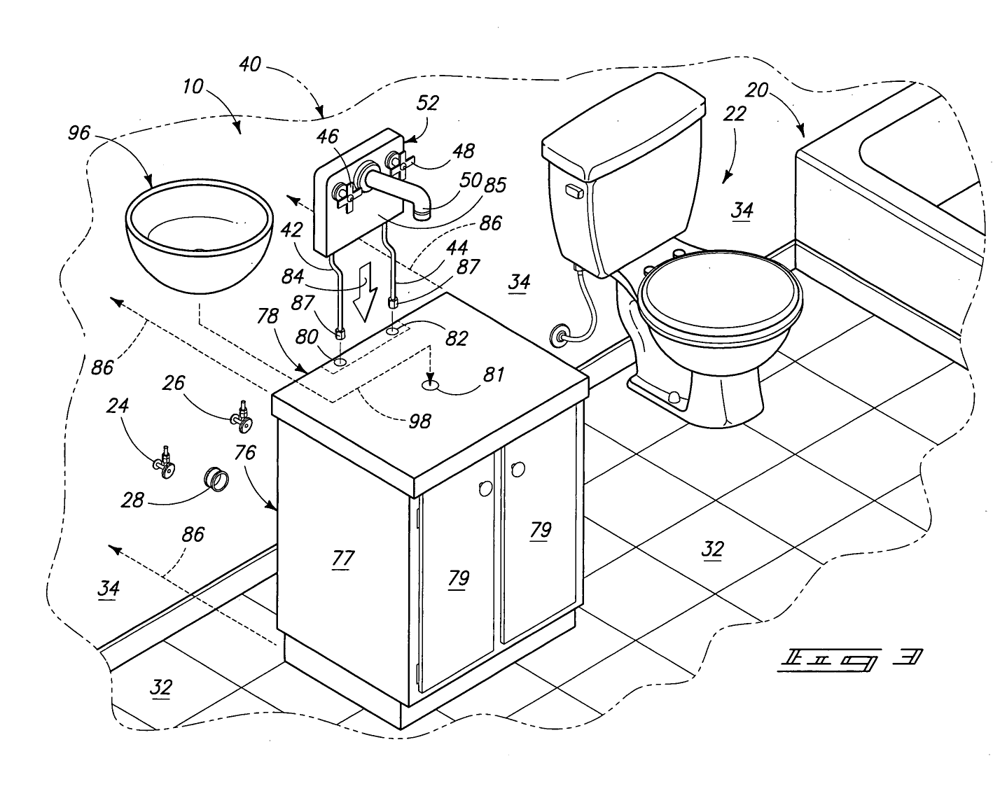

Referring to FIG. 3, an exemplary fluid transfer system 40 according to one embodiment of the invention is illustrated. The exemplary fluid transfer system 40 (also referred to as “transfer system”) is illustrated being provided in bathroom 10. It should be understood that throughout this document with respect to all fluid flow or transfer systems, any structural portion of any one fluid transfer system, and any combination of those structural portion, can be referred to as a fluid regulator. The exemplary bathroom 10 includes the traditional unfinished plumbing system provided in an exemplary building and includes a floor 32, vertical wall 34 extending from the floor 32, and bathtub 20, toilet 22 and cabinet or vanity 76. Supply valves 24 and 26 extend from wall 34 and are the source to a fluid supply, for example, a water supply of the building. Drain flange or opening 28 extends from wall 34 and is for receiving waste water from the transfer system 40 and directs the waste water out the bathroom 10 and building.

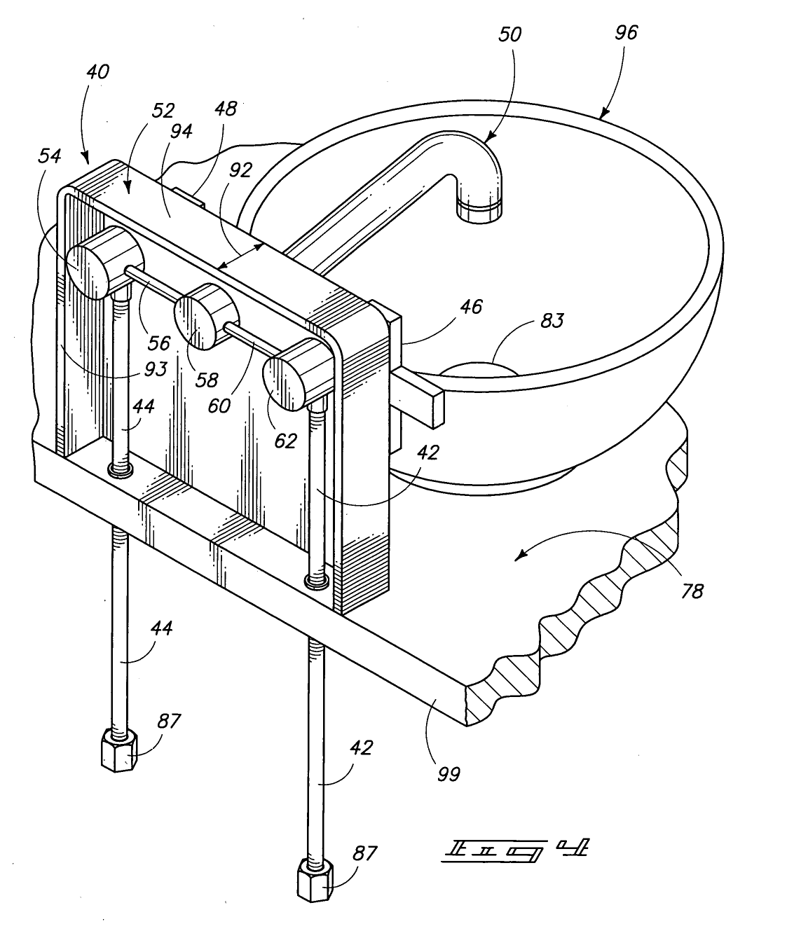

Still referring to FIG. 3, a cabinet 76 is provided in bathroom 10. The invention includes any configuration for cabinet 76, for example, a cabinet with a mirror, with a medicine box and a combination of these structures. Cabinet 76 has opposite sides 77 (two total with only one shown), a third side having doors 79, and a fourth side facing wall 34 (not shown or referenced) that is open to the environment. A countertop 78 (also can be referred to as cabinet top) is provided over, and can be secured to, cabinet 76 providing an uppermost surface of the cabinet 76. Countertop 78 has openings 80 and 82 adjacent an edge of the countertop 78 and that edge being most proximate wall 34. The countertop 78 has a drain opening 81 which is preferably located generally in the center of the surface area of countertop 78. An exemplary sink 96 having a drain opening 83 (shown in FIG. 4) will be provided, for example, along exemplary direction arrow 98 to rest atop countertop 78. Sink 96 is set over countertop 78 with drain opening 83 (FIG. 3) aligned with drain opening 81 of the countertop. An exemplary positioning of the sink 96 includes setting the sink 96 on top of countertop 78 with sink 96 being completely elevationally above countertop 78. Sink 96 represents an exemplary vessel sink as discussed above. Vessel sink 96 is illustrated as having a round configuration such as a bowl. However, sink 96 can have any other shape, for example, elliptical, square and other geometric or non-geometric forms. The rim of sink 96 can range from one-half inch (½) to 24 inches elevationally above countertop 78, with another range being 2 inches to 20 inches, with another range being 4 inches to 14 inches, and with another range being 6 inches to 10 inches.

However, it should be understood sink 96 can have still other configurations, other than the vessel or bowl configuration, for example, a sink configured to be set entirely elevationally below countertop 78. In this example, countertop 78 would have an opening (not shown) to receive sink 96. The opening in countertop 78 can be any configuration or diameter to receive a portion of sink 96 and leaving only a percentage portion of sink 96 elevationally above or exposed above countertop 78. Any exemplary opening (not shown) can be configured to receive any percentage portion of sink 96 and leaving any percentage portion of sink 96 elevationally above or exposed above countertop 78. Another exemplary sink configuration is a double sink configuration. This sink configuration may have a spout capable of swiveling horizontally to access the double sinks.

Still referring to FIG. 3, an exemplary transfer system 40 includes a housing 52 which can have numerous physical configurations and designs. For example, instead of the exemplary rectangular configuration of housing 52, housing 52 could have any geometric or non-geometric shape or configuration, for example, square, diamond and triangle. A first handle 46, a second handle 48 and a spout 50 extend from, and are secured to, a front face 85 of housing 52. A pair of conduits or tubes (or hoses) 42 and 44 extend from the back of housing 52 (more readily seen in FIG. 3) and each conduit 42 and 44 is in fluid communication with spout 50. Each conduit 42 and 44 terminates with a nut 87 for threading onto supply valves 24 and 26 respectively. Rotation of handles 46 and 48 activate respective valves (FIG. 3) secured to back of housing 52 to control and regulate fluid flow through conduits 42 and 44, respectively, and ultimately control and regulate fluid flow through spout 50. The combination of handles 46 and 48 with spout 50 can be collectively referred to as a faucet system. An exemplary fluid includes water wherein hot or warm water will flow through one of conduits 42 and 44 controlled by one of handles 46 and 48, and cold or tepid water will flow through the other of conduits 42 and 44 and controlled by the other of handles 46 and 48. Handles 46 and 48, and spout 50 can have any spatial orientation relative each other and extending from face 85 of housing 52.

It should be understood that other faucet systems are compatible with housing 52, for example, such as a single control faucet. A single control faucet includes a spout and a single handle or lever which controls a single control valve. The single control valve allows both cold and hot fluid in and regulates the volume of each fluid through the spout. That is, the single control valve mixes the hot and cold fluid (water) at any degree of mixture. For example, a first degree would be wherein only cold water is allowed to pass through the single control valve through varying of degrees of allowing varying volumes of hot water to mix with the cold water and pass through the single control valve to ultimately the spout. A final degree of mixture would include the lever being moved to allow only hot water through the spout.

Still referring to FIG. 3, a method of providing the transfer system 40 in an exemplary bathroom 10 is discussed. It should be understood that transfer system 40 can be provided first in bathroom 10 without any of the other structures of bathroom 10, including in no certain order: bathtub 20, toilet 22, cabinet 76, supply valves 24 and 26 and drain flange 28. In this case, housing 52 would be secured to wall 34. A first method step includes countertop 78 being provided on, and in one embodiment secured to, cabinet 76. This step can be performed off site from the building, at the site of the building, or in the bathroom. A second method step includes transfer system 40 being moved in an exemplary direction 84 to be secured to countertop 78. This step can be performed off site from the building, at the site of the building, or in the bathroom. A third method step includes conduit 42 being positioned to extend through opening 80 and conduit 44 being positioned to extend through opening 82. This step can be performed off site from the building, at the site of the building, or in the bathroom. A fourth method step includes cabinet 76 being moved in exemplary direction 86 to be positioned with open fourth side (not shown) adjacent wall 34 over supply valves 24 and 26, and drain opening 28. A fifth method step includes conduit 42 being connected or coupled to valve 24 in fluid communication and includes conduit 44 being connected or coupled to valve 26 in fluid communication. This coupling step includes threading nuts 87 of respective conduits 42 and 44 to respective threads of supply valves 24 and 26. Other coupling methods are possible for conduits 42 and 44 to respective supply valves 24 and 26. A sixth method step includes sink 96 being moved in exemplary direction 98 to be positioned to rest atop countertop 78. This step can be performed off site from the building, at the site of the building, or in the bathroom.

It should be understood that several of these method steps can be provided in any order. For example, the first method step can be performed after the second method step, or after the third method step, or after the fourth method step, or after the fifth method step or after the sixth method step. Still other examples include, the second method step can be performed before the first method step, or after the third method step, or after the fourth method step, or after the fifth method step or after the sixth method step. Moreover, it should be understood that any combination of the method steps can be performed in the bathroom 10, while another combination of different method steps are performed off site from the building, and still yet another combination of different method steps are performed on site of the building but not in the bathroom.

Referring to FIG. 4, a rear perspective of the exemplary fluid transfer system 40 is illustrated after housing 52 is mounted onto countertop 76. Housing 52 has a thickness 92 and a rear edge 93 with thickness being defined from front face 85 (FIG. 3) to rear edge 93. Housing 52 has no back side opposite front face 85 and no bottom side opposite a top side 94. In other exemplary embodiments of housing 52, a back side would be included, or a bottom side would be included, or both. Thickness 92 can range from about half inch (½) to about 24 inches with an exemplary thickness range being about one inch to about four inches. Rear edge 93 is illustrated to be coplanar with a rear edge 94 of countertop 78. In one exemplary embodiment, rear edges 93 and 94 will rest against wall 34 (FIG. 3) once cabinet 76 is moved adjacent or against wall 34. In another exemplary embodiment, rear edges 93 and 94 will extend through wall 34 (FIG. 3) once cabinet 76 is moved adjacent or against wall 34 with any selected percentage of thickness 92 left exposed. In still another exemplary embodiment, housing 52 is moved toward sink 96 leaving rear edge 93 of housing 52 spaced from edge 94 of countertop 78. In this embodiment, edge 94 can rest against wall 34 leaving edge 93 spaced from wall 34. In yet another exemplary embodiment, housing 52 is moved away from sink 96 leaving rear edge 93 of housing 52 spaced from edge 94 of countertop 78. In this embodiment, edge 93 can rest against wall 34 leaving edge 94 spaced from wall 34.

Still referring to FIG. 4, a valve system is partially enclosed by housing 52. The exemplary valve system includes valve body or housing 54, spout body or housing 58 and valve body or housing 62. The valve system further includes a tube or conduit 56 extending between, and providing fluid communication between, valve body 54 and spout body 58. The valve system further includes a tube or conduit 60 extending between, and providing fluid communication between, valve body 62 and spout body 58. Valve body 54 partially houses and supports a valve cartridge 55 wherein a valve is activated by handle 48 (FIG. 4). Valve body 62 partially houses and supports a valve cartridge 63 wherein a valve is activated by handle 46 (FIG. 4). Valve body 54 supports and is in fluid communication with conduit 44 and valve body 62 supports and is in fluid communication with conduit 42.

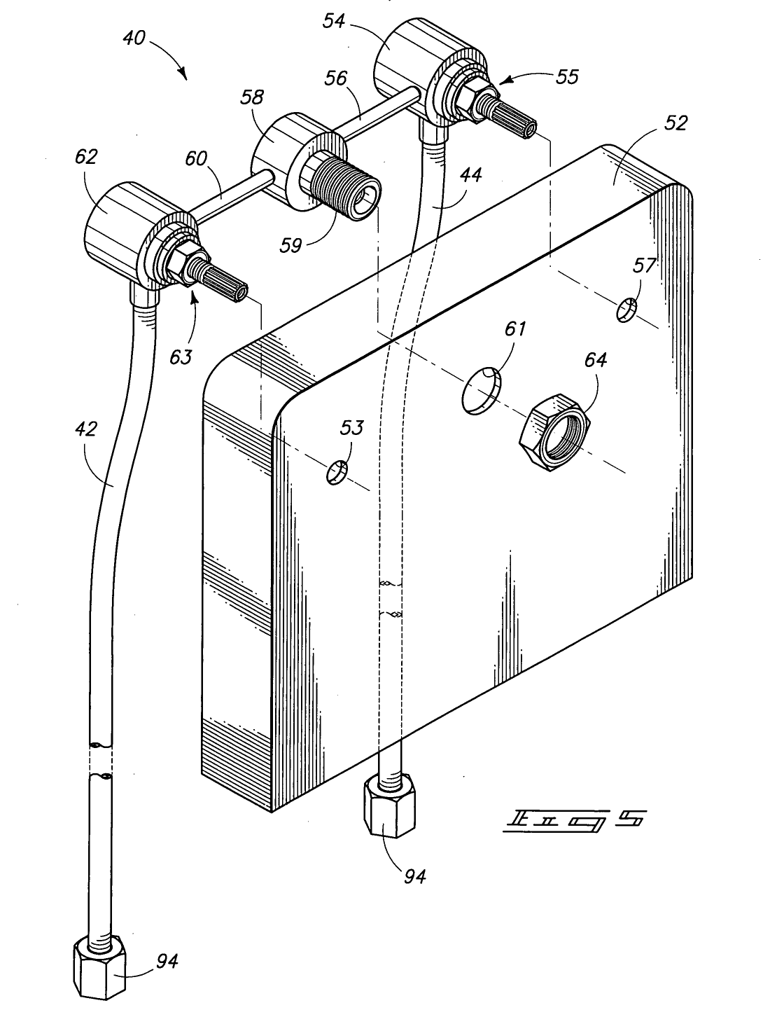

Referring to FIG. 5, housing 52 is illustrated having openings 53, 57 and 61. Valve cartridge 63 has a threaded portion that extends through opening 53 to receive handle 46 and support valve body 62 to housing 52. Valve cartridge 55 has a threaded portion that extends through opening 57 to receive handle 48 and support valve body 54 to housing 52. Spout body 58 has a threaded portion 59 that extends through opening 61 to receive nut 64 and to support spout 50 onto housing 52.

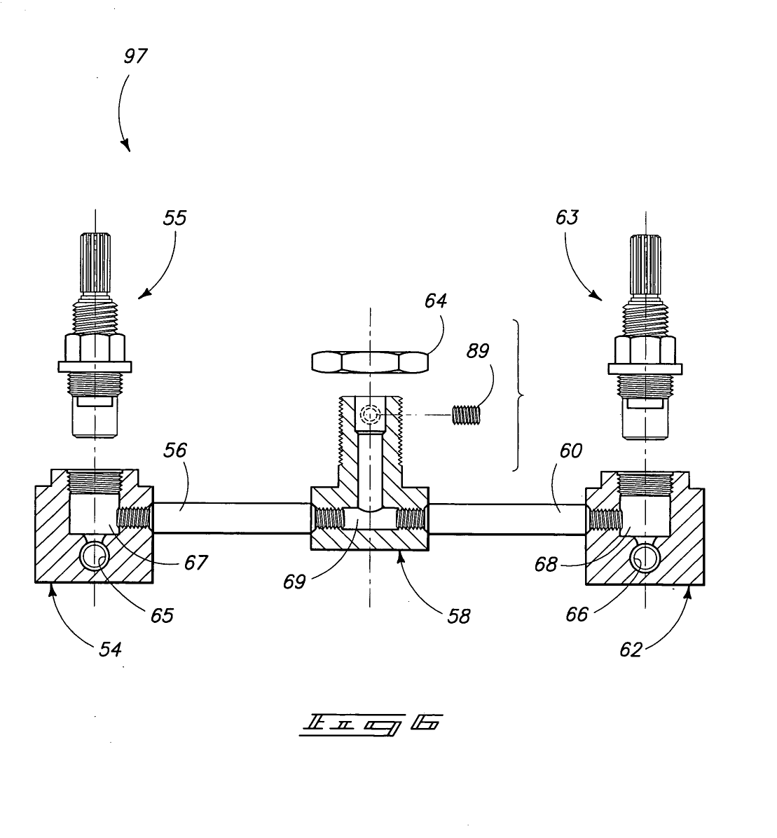

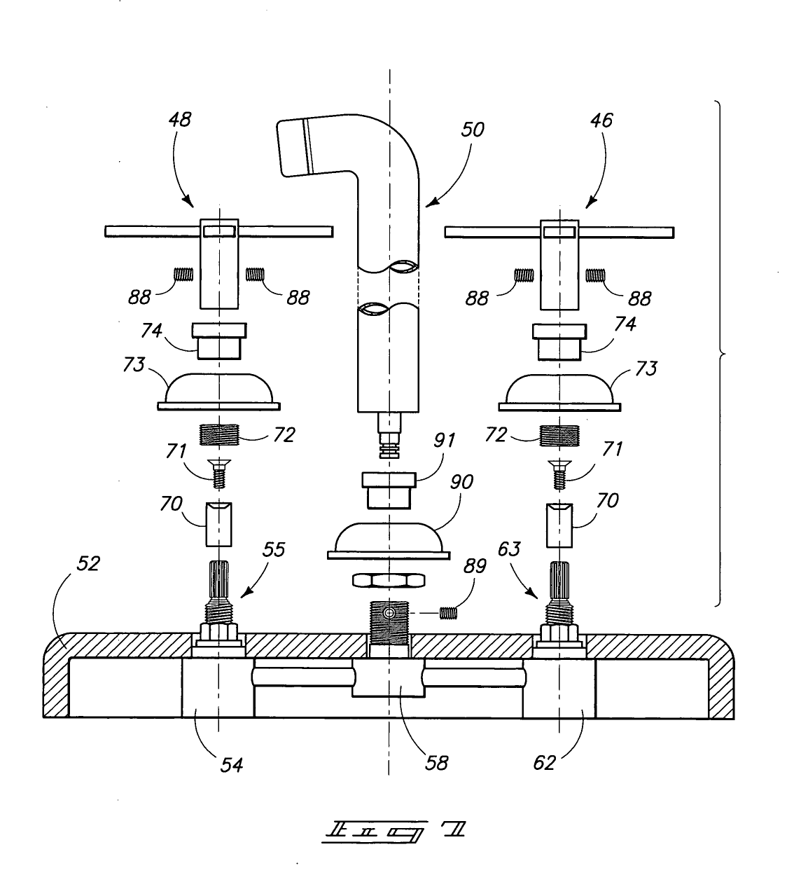

Referring to FIG. 6, mechanical cooperation of structures for one exemplary embodiment of a valve system 97 is illustrated. Valve cartridges 55 and 63 are threaded into valve bodies 54 and 62 respectively. Tube 56 is threaded into valve body 54 and threaded into spout body 58. Tube 60 is threaded into valve body 62 and threaded into spout body 58. Valve body 54 defines a chamber 67 in fluid communication with an inlet 65 which is in fluid communication with conduit 44 (FIG. 5). Valve body 62 defines a chamber 68 in fluid communication with an inlet 66 which is in fluid communication with conduit 42 (FIG. 5). Spout body 58 defines a t-shaped chamber 69 that provides fluid communication to spout 50 (FIG. 7) to valve bodies 54 and 62 via tubes 56 and 60 respectively. Set screw 89 will secure spout 50 (FIG. 7) to spout body 58.

It should be understood that an exemplary fluid transfer system 40 can include and provided with any one of various combinations of the structures previously discussed. For example, one exemplary fluid transfer system 40 includes the structures illustrated in FIG. 5. Moreover, another exemplary fluid transfer system 40 can include the structures illustrated in FIG. 4, and/or minus the spout 50, or minus the handles 46 and 48, or minus the sink 96, or minus the countertop 78 and/or minus any combination of these structures. Still further, another exemplary fluid transfer system 40 can include any of the previously described embodiments combined with the cabinet 76 or any other configuration for a cabinet or vanity.

Referring to FIG. 7, additional structure for an exemplary fluid transfer system 40 is illustrated. Stem sleeves 70 for respective valve cartridges 55 and 63 are provided. Stem screws 71 for respective stem sleeves 70 are provided. Stem adapters 72 are provided for respective handles 46 and 48. Bases or escutcheons 73 for respective handles 46 and 48 are provided against housing 52 over valve cartridges 55 and 63, stem sleeves 70, stem screws 71 and stem adapters 72. Base caps 74 are received in each base 73 and each base cap 74 receives one of handles 46 and 48. Each handle 46 and 48 receives a plurality of set screws 88, for example, two set screws 88 to be secured ultimately to housing 52.

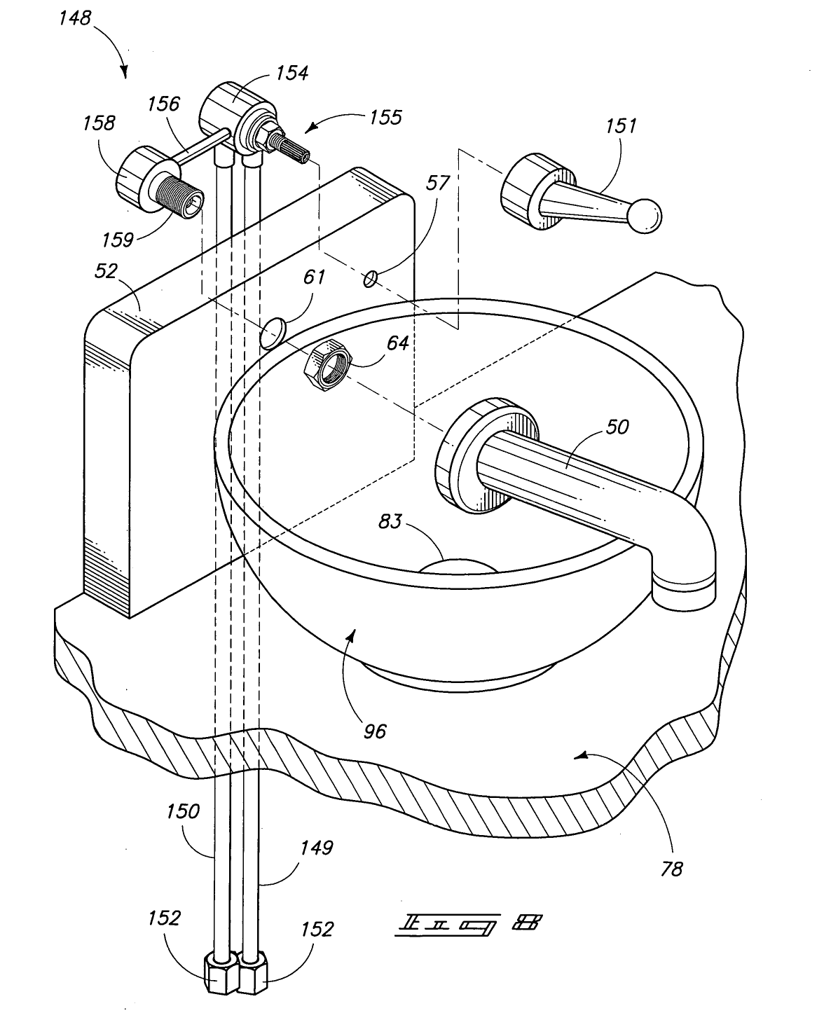

Referring to FIG. 8, another exemplary embodiment of a fluid transfer system 148 is illustrated. The fluid transfer system 148 includes a housing 52 having a single handle 151 to activate hot and cold water through spout 50. Fluid transfer system 148 further includes a countertop 78 to receive vessel sink 96 which includes drain opening 83. Fluid transfer system 148 has a single valve body or housing 154 provided with valve cartridge 155 which is positioned through opening 57 of housing 52 to be secured to single handle 151. Single valve body 154 includes hoses 149 and 150 (with nuts 152 for securing hoses 149 and 150) which ultimately provide hot and cold water through spout 50. Single valve body 154 is in fluid communication with spout body 158 via conduit 156 and includes treaded portion 159 to be provided through opening 61 of housing 52. Nut 64 secures spout 50 to the threaded portion 159 of spout body 158. It should be understood that all structures and method steps discussed with regard to fluid transfer system 148 are applicable to all fluid transfer systems disclosed in this document.

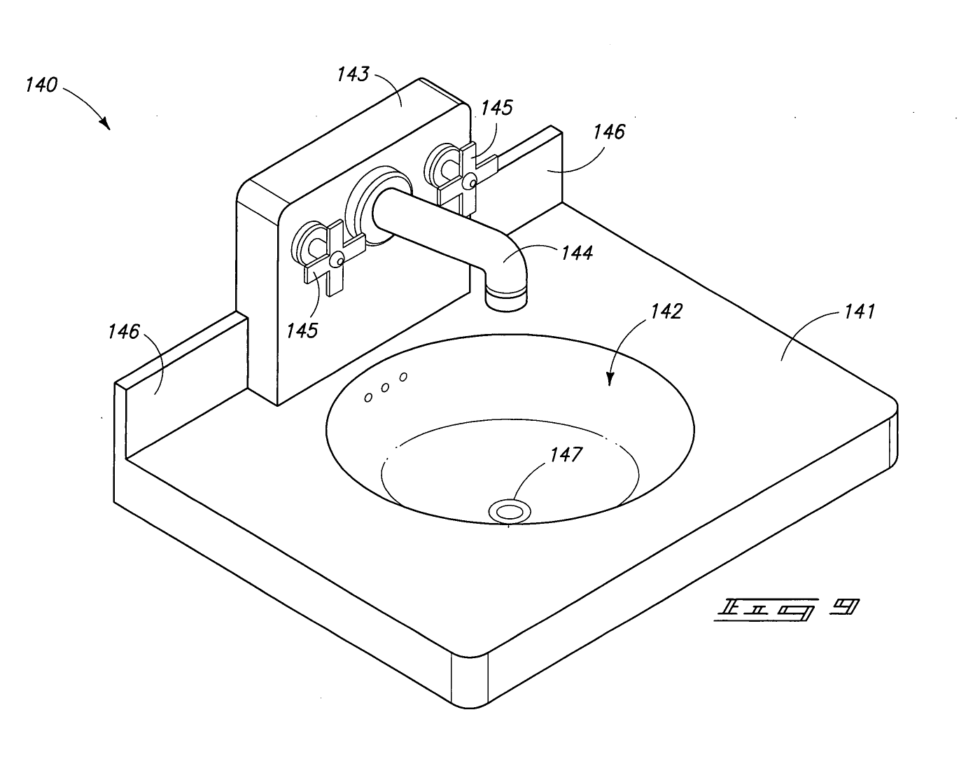

Referring to FIG. 9, another exemplary embodiment of a fluid transfer system 140 is illustrated. The fluid transfer system 140 includes a housing 143 having handles 145 and spout 144. Fluid transfer system 140 further includes a countertop 141 having a backsplash 146 and a cavity 142 which functions as a sink 142. Sink 142 includes a drain opening 147. One embodiment of sink 142 is as an integral structure or single construction with the countertop 141. In another embodiment of sink 142, sink 142 is a separate and discrete structure relative countertop 141 and is secured to an opening in the countertop 141. It should be understood that all structures and method steps discussed with regard to fluid transfer system 40 are applicable to any and all fluid transfer systems disclosed in this document.

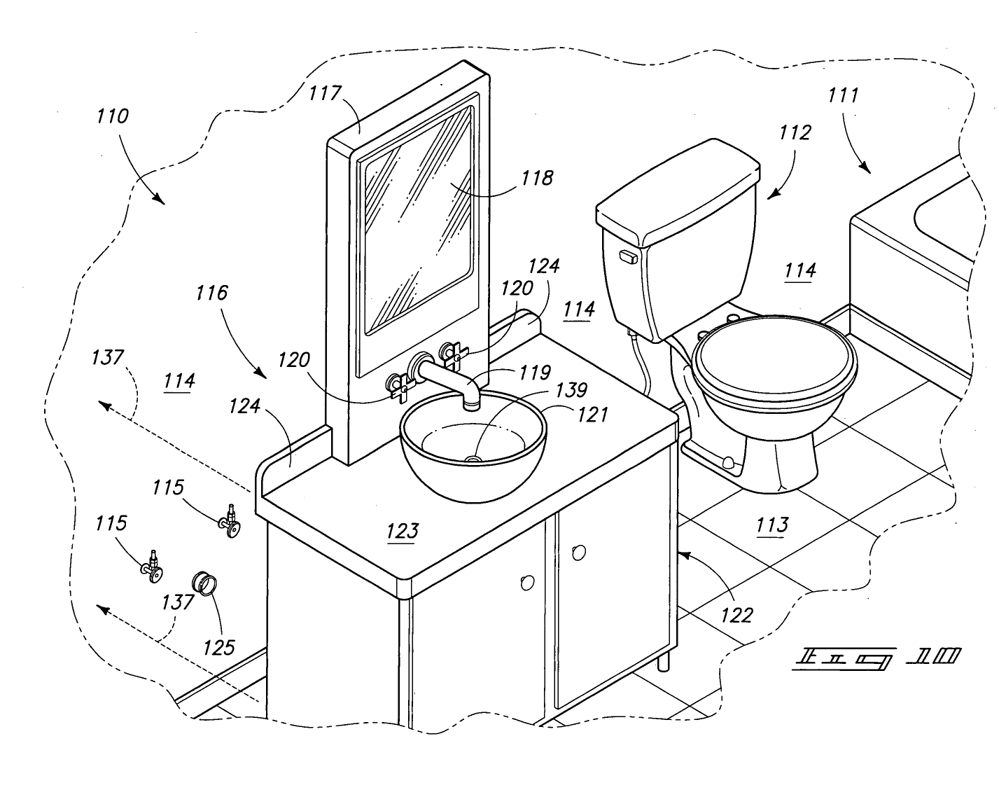

FIG. 10 illustrates a perspective view of another exemplary bathroom 110 which is modified according to one of various methods of the invention. Bathroom 110 can for any type of building, public or private, including a business, manufacturing company or factory, dwelling or home, public or private mall, etc. The exemplary bathroom 110 includes a bathtub 111 (and/or shower) and a toilet 112 over a floor 113 and adjacent a wall 114. It should be understood that, either the bathtub 111 or toilet 112, or both, can be missing in any one of exemplary bathrooms 110.

Still referring to FIG. 10, the illustrated exemplary bathroom 110 includes supply valves 115 and drain opening 125 extending from wall 114. Supply valves 115 are, or will be, provided in fluid communication with a fluid source of the building to the bathroom 110 wherein an exemplary fluid source is water. Drain opening or flange 125 is, or will be, provided in fluid communication with an evacuation conduit (not shown) exiting the bathroom 110 and ultimately the building. It should be understood that each valve 115 can be oriented in any position relative the other, and each valve 115 can be oriented in any position relative the drain opening 125. Moreover, each valve 115 can be oriented in any position relative the floor 113, toilet 112 and/or bathtub 111. Furthermore, each valve 115 can be oriented in any position along wall 114, for example, more distant or proximate relative the floor 113, or more distant or proximate relative the toilet 112 and/or the bathtub 111. Still further, one or both valves 115 could extend from floor 113 instead of wall 114.

Still referring to FIG. 10, an exemplary fluid transfer system 116 (also referred to as “transfer system”) according to another embodiment of the invention is illustrated in bathroom 110. The exemplary bathroom 110 has a cabinet 122 with a countertop 123 over cabinet 122 and a backsplash extending from countertop 123. An exemplary sink 121 having a drain opening 139 rests atop countertop 123. Sink 121 represents an exemplary vessel sink as discussed above, and can have any shape, for example, elliptical, square and other geometric or non-geometric forms. The rim of sink 121 can range from one-half inch (½) to 24 inches elevationally above countertop 123 with an exemplary range being from about 5 inches to about 10 inches. However, it should be understood sink 121 can have still other configurations, other than the vessel or bowl configuration, for example, a sink configured to be set entirely elevationally below countertop 123.

Still referring to FIG. 10, an exemplary transfer system 116 includes a housing 117 which can have numerous physical configurations and designs. An exemplary configuration of housing 117 includes a mirror 118. Another exemplary configuration of housing 117 includes a medicine cabinet (not shown) having a door with a handle in place of the mirror 118. Alternatively, housing 117 can have the medicine cabinet and the mirror. Handles 120 and a spout 119 extend from, and are secured to, housing 117. Rotation of handles 120 activate respective valves (FIG. 9) secured to a back of housing 117 to control and regulate fluid flow through spout 119. Handles 120 and spout 119 can have any spatial orientation relative each other and extending from housing 117. Cabinet 122 is moved along direction lines 137 against wall 114 over supply valves 115 and drain flange 125. Cabinet 122 can be moved against wall 114 alone and first, or with any combination of one or more of housing 117, sink 121 and/or countertop 123. It should be understood that all structures and method steps discussed with regard to fluid transfer system 116 are applicable to any and all fluid transfer systems disclosed in this document.

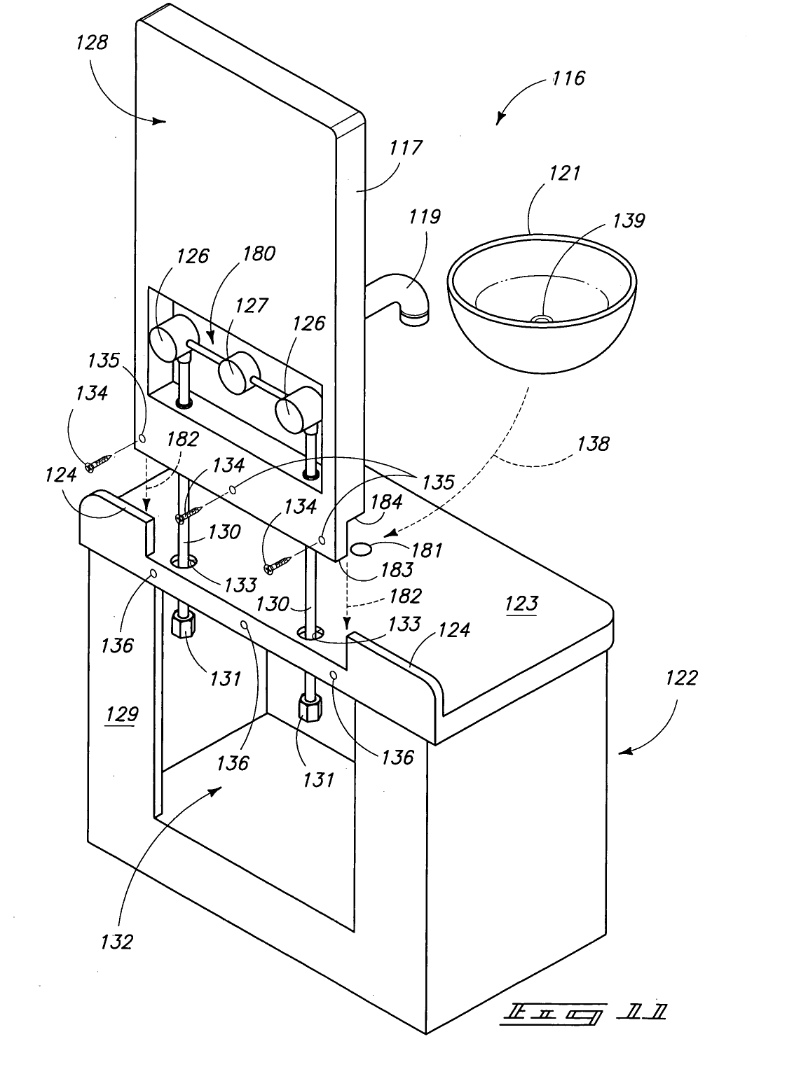

Referring to FIG. 11, a rear perspective of the exemplary fluid transfer system 116 is illustrated with housing 117 and sink 121 being mounted onto countertop 123. Sink 121 is moved along direction arrow 138 to be positioned over countertop 123 with drain opening 139 of sink 121 aligned over drain opening 181 of countertop 123. Housing 117 has a back or rear wall 128 which defines a cavity 180 to receive a valve system. The valve system can have the same structures as previously described valve systems and includes valve bodies 126 and spout body 127. Housing 117 is moved along direction arrows 182 to be received and supported on countertop 123. Conduits 130 of the valve system are provided through openings 133 in countertop 123. Conduits 130 terminate with nuts 131 suspended within a substantially enclosed region 132 of cabinet 122. Housing 117 has openings 135 which are to be aligned with openings 136 in rear surface of countertop 123. Upon alignment, openings 135 and 136 will receive screws 134 to secure housing 117 to countertop 123 and cabinet 122. Housing 117 has a bottommost surface comprising a first step surface 183 and a second step surface 184. Upon positioning housing 117 onto countertop 123, second step surface 184 will rest on countertop 123 with first step surface 183 positioned elevationally below an upper surface of countertop 123 and extending between wall 114 and countertop 123.

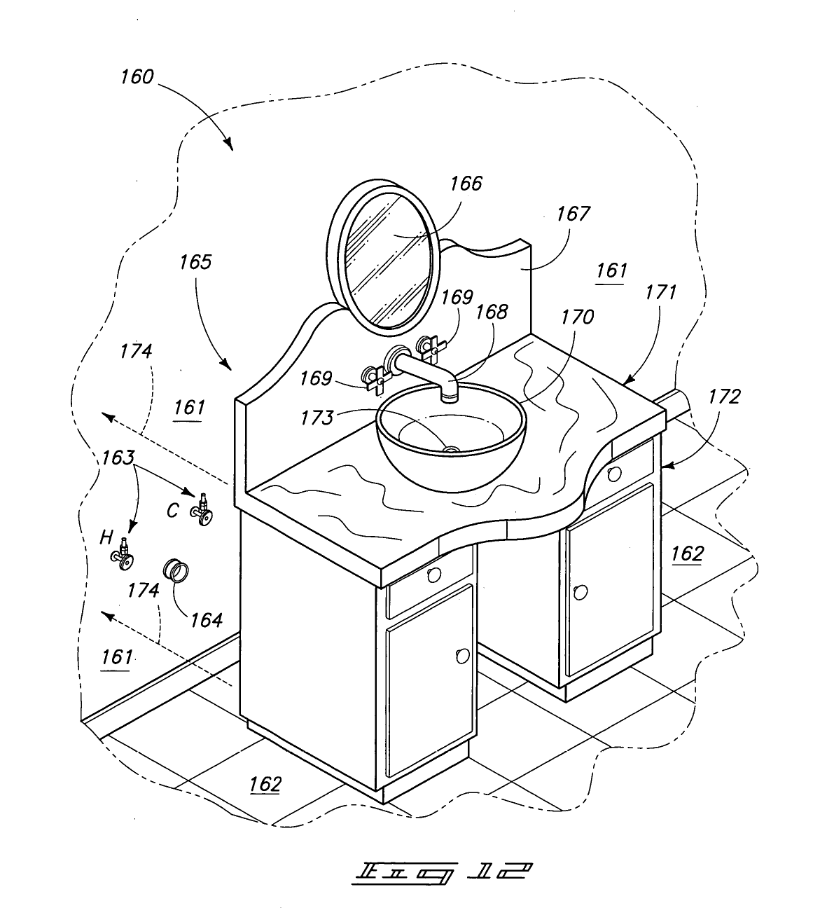

FIG. 12 illustrates a perspective view of another exemplary bathroom 160 which is modified according to one of various methods of the invention. Bathroom 160 can for any type of building, public or private, including a business, manufacturing company or factory, dwelling or home, public or private mall, etc. It should be understood that exemplary bathroom 160 can include a bathtub and/or toilet. Bathroom 160 includes supply valves 163 and drain opening or flange 164 extending from wall 161. Supply valves 163 are, or will be, provided in fluid communication with a fluid source of the building to the bathroom 160 wherein an exemplary fluid source is water. Drain flange 164 is, or will be, provided in fluid communication with an evacuation conduit (not shown) exiting the bathroom 160 and ultimately the building. It should be understood that each supply valve 163 can be oriented in any position relative the other, and each supply valve 163 can be oriented in any position relative the drain flange 164. Furthermore, each supply valve 163 can be oriented in any position along wall 161 or a floor 162, for example, more distant or proximate relative the floor 162. Still further, one or both valves 163 could extend from floor 162 instead of wall 161.

Still referring to FIG. 12, an exemplary fluid transfer system 165 (also referred to as “transfer system”) according to another embodiment of the invention is illustrated in bathroom 160. The exemplary bathroom 160 has a cabinet 172 with a countertop 171 over cabinet 172 wherein a backsplash 167 extends vertically from countertop 171. In this exemplary embodiment of transfer system 165, there is no housing. However, it should be understood that backsplash 167 could be replaced with a housing as described in the previous exemplary embodiments or have a housing in combination with backsplash 167. An exemplary sink 170 having a drain opening 173 rests atop countertop 171. Sink 170 represents an exemplary vessel sink as discussed above, and can have any shape, for example, elliptical, square and other geometric or non-geometric forms. The rim of sink 170 can range from one-half inch (½) to 24 inches elevationally above countertop 171 with an exemplary range being from about 5 inches to about 10 inches. However, it should be understood sink 170 can have still other configurations, other than the vessel or bowl configuration, for example, a sink configured to be set entirely elevationally below countertop 171.

Still referring to FIG. 12, the exemplary backsplash 167 can have numerous physical configurations and designs. An exemplary configuration of backsplash 167 includes a mirror 166. Another exemplary configuration of backsplash 167 includes a medicine cabinet (not shown) having a door with a handle in place of the mirror 166. Alternatively, backsplash 167 can have the medicine cabinet and the mirror. Handles 169 and a spout 168 extend from, and are secured to, backsplash 167. Rotation of handles 169 activate respective valves (not shown) secured to a back portion of backsplash 167 to control and regulate fluid flow through spout 168. Handles 169 and spout 168 can have any spatial orientation relative each other. Cabinet 172 is moved along direction lines 174 against wall 161 over supply valves 163 and drain flange 164. Cabinet 172 can be moved against wall 161 alone and first, or with any combination of one or more of sink 170 and/or countertop 171.

It should be understood that conduits (not shown) will connect handles 169 to supply valves 163 and provide fluid communication between spout 168 and a fluid source such as water. The conduits will be positioned between wall 161 and the back of cabinet 172 and backsplash 167. It should be understood that all structures and method steps discussed with regard to fluid transfer system 165 are applicable to any and all fluid transfer systems disclosed in this document.

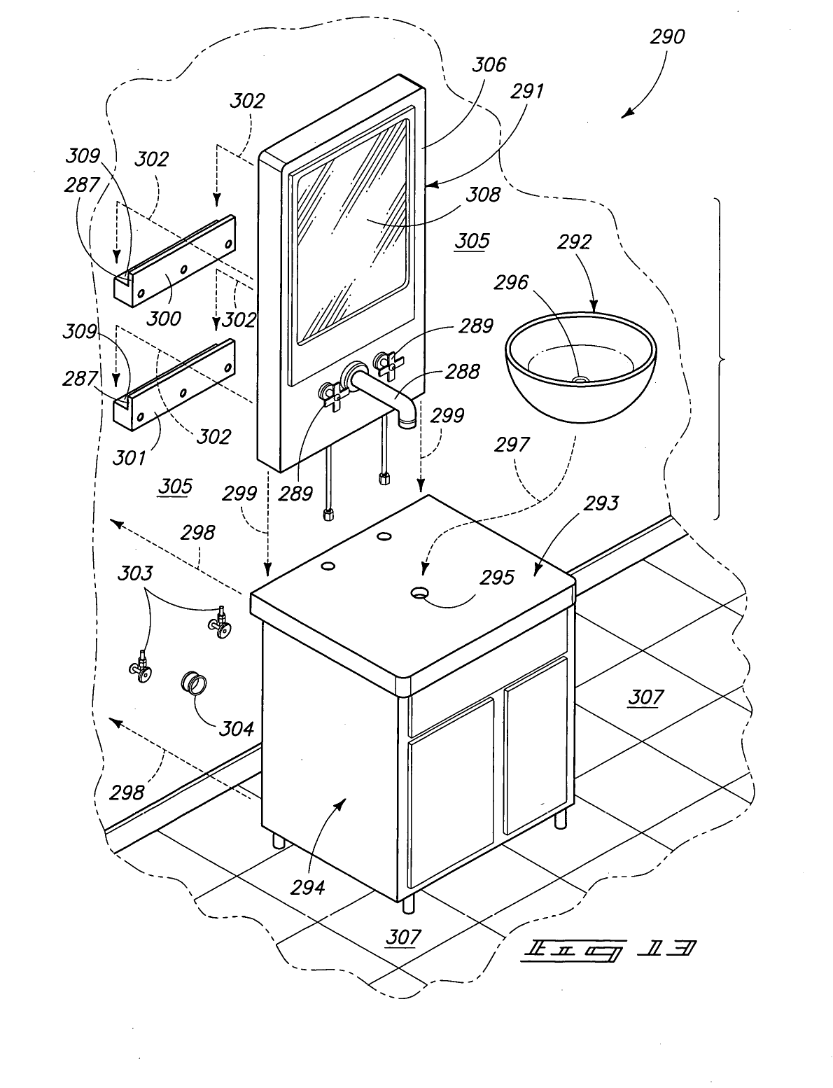

FIG. 13 illustrates a perspective view of another exemplary bathroom 290 which is modified according to one of various methods of the invention. Bathroom 290 can for any type of building, public or private, including a business, manufacturing company or factory, dwelling or home, public or private mall, etc. It should be understood that exemplary bathroom 290 can include a bathtub and/or toilet. Bathroom 290 includes supply valves 303 and drain opening or flange 304 extending from wall 305. Supply valves 303 are, or will be, provided in fluid communication with a fluid source of the building to the bathroom 290 wherein an exemplary fluid source is water. Drain flange 304 is, or will be, provided in fluid communication with an evacuation conduit (not shown) exiting the bathroom 290 and ultimately the building. It should be understood that each supply valve 303 can be oriented in any position relative the other supply valve 303, and each supply valve 303 can be oriented in any position relative the drain flange 304. Furthermore, each supply valve 303 can be oriented in any position along wall 305, for example, more distant or proximate relative floor 307. Still further, one or both supply valves 303 could extend from the floor 307 instead of wall 305.

Still referring to FIG. 13, an exemplary fluid transfer system 291 (also referred to as “transfer system”) according to another embodiment of the invention is illustrated in bathroom 290. The exemplary bathroom 290 has a cabinet 294 wherein a countertop 293 is over cabinet 294. The exemplary embodiment of transfer system 291 includes a housing 306 with a mirror 308. It should be understood that transfer system 291 and housing 306 can be configured and include all the structures of previously described exemplary embodiments of fluid transfer systems and housings. An exemplary sink 292 has a drain opening 296 and the countertop 293 has a drain opening 295. The sink 292 is positioned along direction arrow 297 to rest atop countertop 293 with drain openings 295 and 296 aligned. Sink 292 represents an exemplary vessel sink as discussed above, and can have any shape, for example, elliptical, square and other geometric or non-geometric forms. The rim of sink 292 can range from one-half inch (½) to 24 inches elevationally above countertop 293 with an exemplary range being from about 5 inches to about 10 inches. However, it should be understood sink 292 can have still other configurations, other than the vessel or bowl configuration, for example, a sink configured to be set entirely elevationally below countertop 293.

Still referring to FIG. 13, the exemplary housing 306 of fluid transfer system 291 can have numerous physical configurations and designs. Housing 306 includes handles 289 and spout 288 wherein rotation of handles 289 activate respective valves (not shown) secured to a back portion of housing 306 to control and regulate fluid flow through spout 288. Cabinet 294 is moved along direction lines 298 against wall 305 over supply valves 303 and drain flange 304. Cabinet 294 can be moved against wall 305 alone and first, or with any combination of one or more of cabinet 294, sink 292 and/or countertop 293.

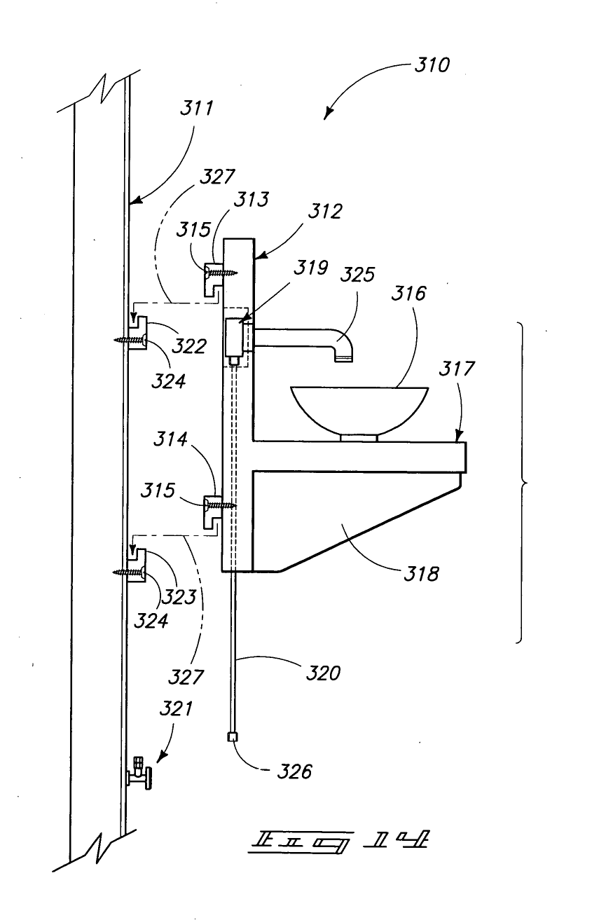

Still referring to FIG. 13, one exemplary embodiment of fluid transfer system 291 has housing 306 being moved individually along direction arrow 302 to be secured to wall 305 by being positioned on cleats 300 and 301. Cleats 300 and 301 are secured to wall 305 and each cleat 300 and 301 has a corresponding cleat (not shown) extending from the back side of housing 306 oriented in the opposite direction (see FIG. 14). Each cleat 300 and 301 (and cleats not shown) has a receiving surface 309 extending from wall 305 to a retaining ridge 287. For cleats 300 and 301, the retaining ridges 287 extend upward from each receiving surface 309. For the cleats not shown which are oriented in the opposite direction on the back side of housing 306, the retaining ridges extend downward from each receiving surface (see FIG. 14). Accordingly, to secure housing 306 to wall 305, the receiving surfaces 309 of each cleat 300 and 301 receives a corresponding retaining ridge from the cleats not shown (extending from housing 306) wherein the not shown retaining ridges are positioned between wall 305 and retaining ridges 287 of each cleat 300 and 301 (see FIG. 14). Correspondingly, each cleat not shown receives the retaining ridges 287 of cleats 300 and 301. Consequently, all four cleats receive a corresponding retaining ridge of another cleat. Therefore, exemplary housing 306 can be secured to wall 305 without being positioned or supported on countertop 293. In an alternative embodiment, housing 306 is supported on and secured to wall 305 in addition to being secured and supported onto countertop 293 along direction arrows 299. For this alternative embodiment, housing 306 can be secured to wall 305 before, or after, being secured to countertop 293.

It should be understood that each cleat 300 and 301 could be replaced by rectangular openings formed in wall 305 wherein the cleats not shown extending from housing 306 could be placed in the rectangular openings. It should be understood that housing 306 could be secured to wall 305 via cleats before any of the other structures are provided, including the handles, spout, countertop, cabinet, sink, supply valves and drain flanges. It should be understood that all structures and method steps discussed with regard to fluid transfer system 291 are applicable to any and all fluid transfer systems disclosed in this document.

FIG. 14 illustrates a side view of another exemplary fluid transfer system 310 according to one of various embodiments of the invention. Supply valve(s) 321 extends from wall 311. A drain opening or flange would extend from wall 311 and is not shown to simplify the illustration. All previous discussions of previously disclosed embodiments of bathrooms, buildings, supply valves and drain flanges are applicable to these same structures for this embodiment, and therefore, are not discussed further. Cleats 322 and 323 are secured to wall 311 by screws 324. It should be understood that wall 311 can be in any room of a building, for example, a bathroom, and alternatively could be an outside wall of a building. Furthermore, it should be understood that all previously described embodiments of fluid transfer systems could be provided on an outside wall of a building.

The exemplary fluid transfer system 310 is a singular, monolithic structure, a modular structure which acts as a support structure for other structures discussed subsequently. Transfer system 310 has a vertical portion 312 and a horizontal portion 317 extending from the vertical portion 312. Transfer system 310 can be cast in concrete, formed from a single rock or marble slab, or even from wood. The vertical portion 312 supports valve system 319, spout 325, conduit 320 having coupler or nut 326, and handles which are not shown to simplify the illustration. The horizontal portion 317 supports basin or vessel 316 wherein drain openings in vessel 316 and horizontal portion 317 are aligned. All previous discussions of previously disclosed embodiments of drain openings, valve systems, spouts, conduits, nuts, sinks and cooperation or interaction between the respective structures are applicable to these same structures for this embodiment, and therefore, are not discussed further. A support bridge 318, which is optional, extends between vertical portion 312 and horizontal portion 317 to provide additional support to horizontal portion 317. Cleats 313 and 314 extend from a side of vertical portion 312 opposite the horizontal portion 317 and are secured with screws 315. The fluid transfer system 310 is secured to wall 311 by moving cleats 313 and 314 along direction arrow 327 to be positioned in cleats 322 and 323 secured to wall 311. The interaction or cooperation between the cleats is thoroughly discussed with respect to FIG. 11, and therefore, will not be further discussed here.

It should be understood that each cleat 322 and 323 could be replaced by rectangular openings formed in wall 311 wherein the cleats 313 and 314 extending from fluid transfer system 310 would be placed in the rectangular openings to support the fluid transfer system 310 to wall 311. It should be understood that the modular fluid transfer system 310 can have all the structure provided thereon shown in the Fig. before placing on wall 311, and alternatively, just the modular structure with the horizontal and vertical portions 317 and 312 placed on the wall 311 first with the other structures provided later, including spout 325, sink 316, mirror, medicine cabinet, etc. It should be understood that all structures and method steps discussed with regard to fluid transfer system 310 are applicable to any and all fluid transfer systems disclosed in this document.

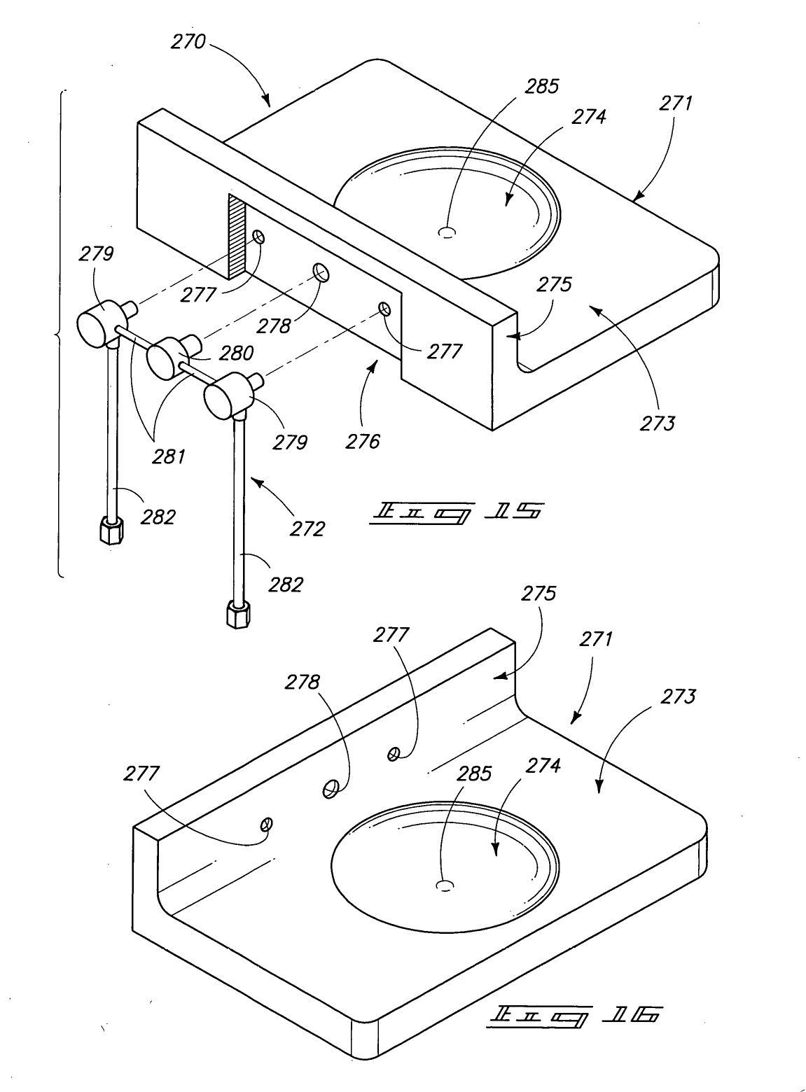

FIGS. 15-17 illustrate perspective views of another exemplary modular or monolithic fluid transfer system 270 according to one of various embodiments of the invention. Referring to FIG. 15, fluid transfer system 270 includes a countertop 271 that can be cast in concrete, formed from a single rock or marble slab, or even from wood. Countertop 271 includes an upper surface 273 having a sunken region for a sink 274 which has a drain opening 285. A vessel sink could be used instead of sunken region 274, or any other configuration for a sink. Countertop 271 has a backsplash 275 having openings 277 and 278 laterally or horizontally spaced.

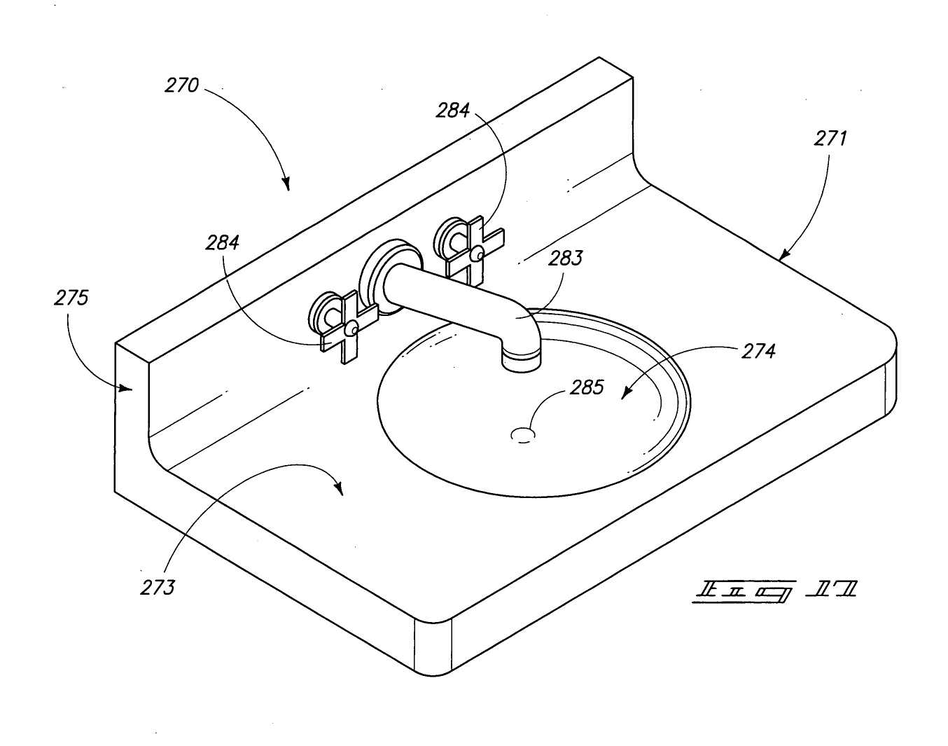

Referring to FIG. 16, a simplistic rendering of a valve system 272 is shown for ease of description and is compatible with all the previous discussions of valve systems. Valve system 272 includes conduits 282, valve bodies 279, spout body 280 and tubes 281. A rear portion of backsplash 275 has a hollowed-out or recessed region 276 to receive valve system 272 wherein valve bodies 279 are positioned through openings 277 and spout body 280 is positioned through opening 278.

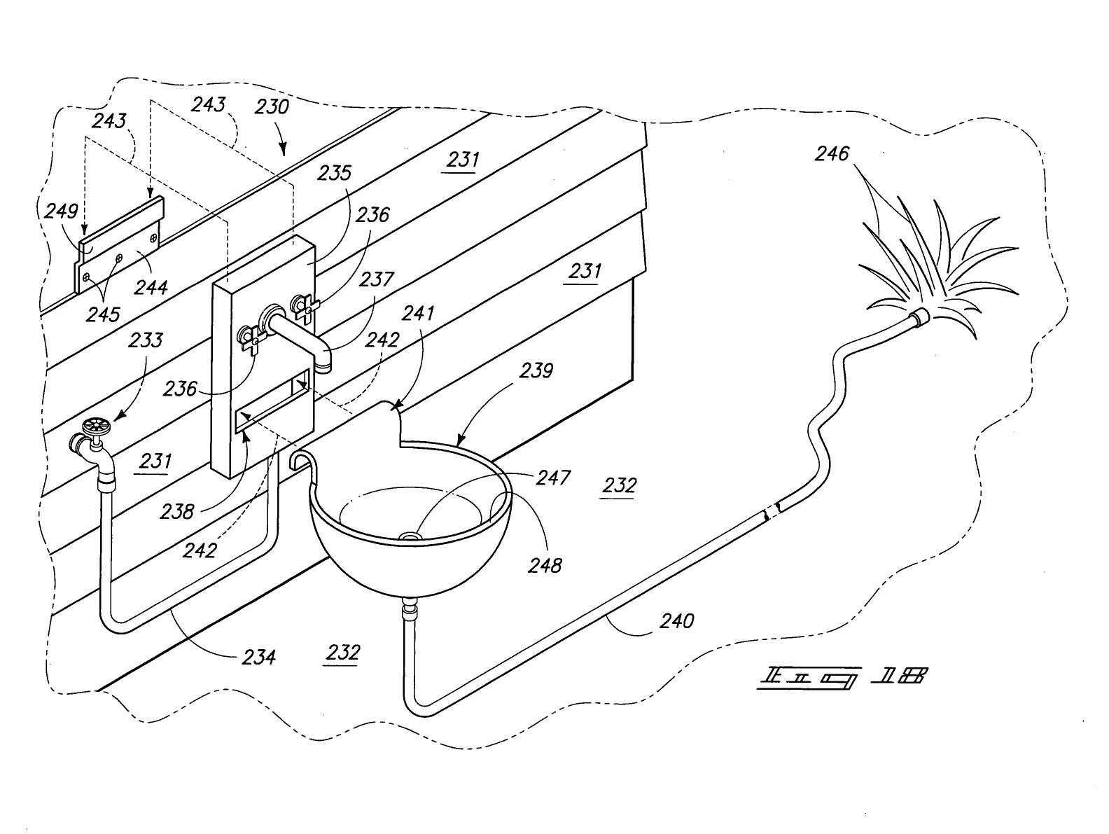

Referring to FIG. 17, handles 284 are secured onto valve bodies 279 (FIG. 16) adjacent backsplash 275 and spout 283 is secured to spout body 280 (FIG. 16) between handles 284. It should be understood that additional structure for operation is provided as disclosed with the previously described embodiments, such as, supply valves and drain flanges. It should be understood that a wall for supporting fluid transfer system 270 can be in any room of a building, for example, a bathroom, and alternatively could be provided on an outside wall of a building. It should be understood that all structures and method steps discussed with regard to fluid transfer system 270 are applicable to any and all fluid transfer systems disclosed in this document.

As previously stated, all the previously described inventive embodiments of fluid transfer systems could be provided on an outside wall of a building. That is, all the previously described inventive embodiments of fluid transfer systems are interchangeable between rooms and interchangeable between inside of a building versus outside of a building. All the previously described inventive embodiments of fluid transfer systems can be provided on any wall first, whether inside or outside, and then removed from the wall and placed or secured to another wall. The exemplary fluid transfer systems described in this document can be easily removed from multiple walls and placed on other multiple walls. The following described inventive embodiments of exemplary fluid transfer systems are described for securing to an outside wall or at least placed outside a building. It should be understood that all subsequent described embodiments can be placed and secured to an inside wall such as a bathroom. Moreover, it should be understood that with the inventive exemplary fluid transfer systems being able to be placed outside a building, outdoor events such as picnics and barbeques are more enjoyable wherein participants can readily clean themselves without entering the building. After the outdoor event is finished, the inventive exemplary fluid transfer system can be removed from outdoors and reconnected (or for first time connected) to a water source in any room of the building.

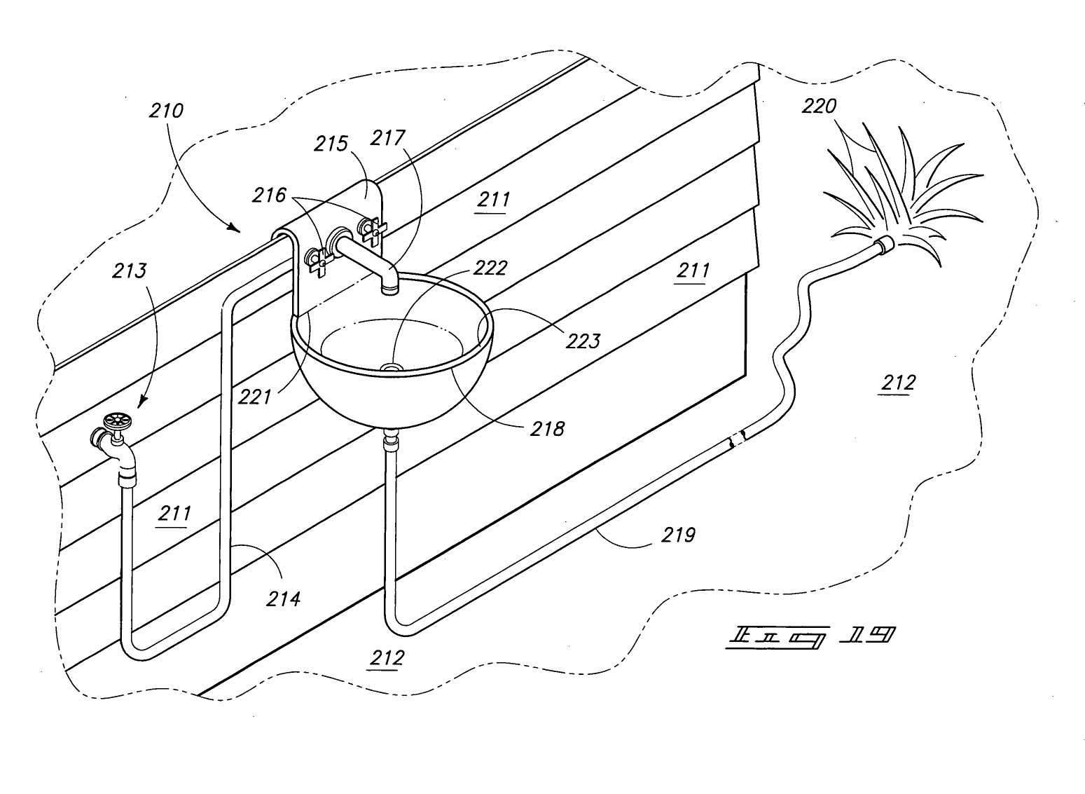

FIG. 18 illustrates a perspective view of another exemplary fluid transfer system 230 according to one of various embodiments of the invention. An exemplary wall 231 is an outside wall of a building and has a cleat 244 secured thereon with screws 245 and a water spigot 233 extending outwardly. A housing or enclosure 235 includes handles 236, a valve system not shown and a spout 237. It should be understood that housing 235 will have all the previously described structures such as valve systems even though not shown. Housing 235 has an opening 238, rectangular in shape to receive a sink 239. Sink 239 has a bowl shape with an upper rim 248, a curved portion 241 extending upward from upper rim 248 and a drain opening 247 secured to a hose such as a garden hose 240 for evacuation of fluid such as water to bushes 246. Sink 239 is moved along direction arrows 242 to provide curved portion 241 in opening 238 of housing 235 to allow sink 239 to be supported upon housing 235. Housing 235 is secured to wall 231 by moving housing 235 along direction arrow 243 onto cleat 244 either in a fashion previously described (wherein housing 235 has a cleat) or by a portion of housing 235 being positioned in between wall 235 and a retaining ridge 249 of cleat 244. A water hose 234 is secured to spigot 233 and connected directly or indirectly to housing 235 to provide fluid communication with spout 237. An indirect connection would include the valve system of housing 235 having conduits (not shown) as described in previous embodiments, and hose 234 is coupled to the conduit. Alternatively, the not shown conduit could be directly connected to spigot 233 to provide water to spout 237. It should be understood that all structures and method steps discussed with regard to fluid transfer system 230 are applicable to any and all fluid transfer systems disclosed in this document.

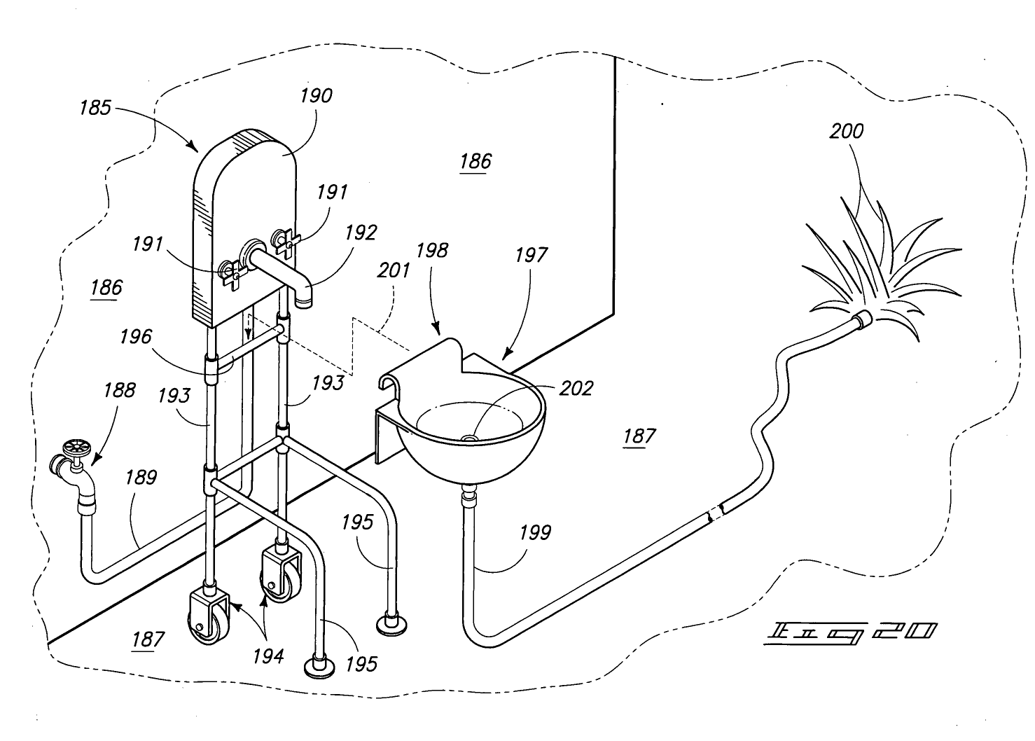

FIG. 19 illustrates a perspective view of another exemplary fluid transfer system 210 according to one of various embodiments of the invention. An exemplary wall 211 is an outside wall of a building and includes a plurality of panels. A water spigot 213 extends outwardly from wall 211. Fluid transfer system 210 is a unitary integral structure of a sink 218 and faucet 215 combination. It should be understood that fluid transfer system 210 will have all the previously described structures such as valve systems even though not shown. Faucet 215 includes handles 216 and spout 217. Sink 218 has an upper rim 223 and drain opening 222 secured to a hose 219 for fluid evacuation to the environment such as a bush 220. Faucet 215 extends upward from upper rim 223 of sink 218 generally at line 221. Faucet 215 terminates in a curved portion which is used to be provided over a panel of wall 211. Alternatively, the curved portion of faucet 215 could be provided over a cleat (not shown) secured to wall 211. Moreover, it should be understood that instead of a unitary structure, fluid transfer system 210 could be two structures divided at line 221 with faucet 215 secured to sink 218 at line 221. The line 221 connection could be configured to allow sink 218 and/or faucet 215 to pivot relative the other and a gear structure (not shown could be provided to hold a pivot position in place. A water hose 214 is secured to spigot 213 and connected directly or indirectly to faucet 215 to provide fluid communication with spout 217. An indirect connection would include a valve system (not shown) behind faucet 215 as having conduits (not shown) as described in previous embodiments, and hose 214 is coupled to the conduit. Alternatively, the not shown conduit could be directly connected to spigot 213 to provide water to spout 217. It should be understood that all structures and method steps discussed with regard to fluid transfer system 210 are applicable to any and all fluid transfer systems disclosed in this document.

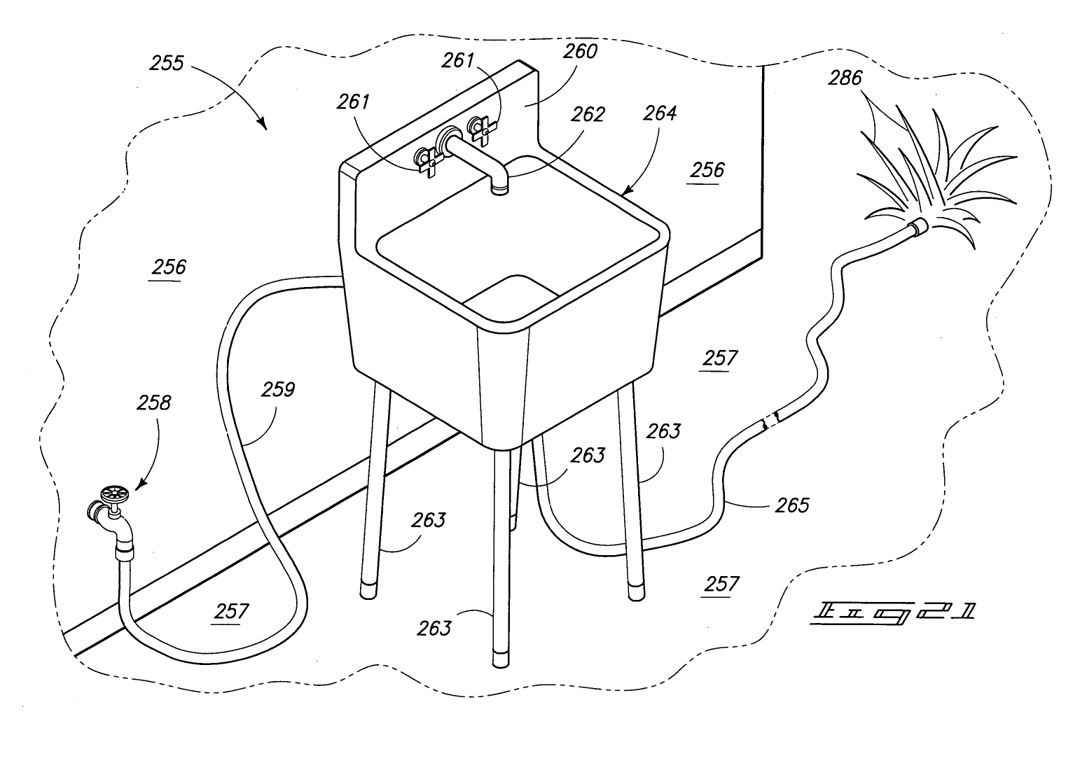

FIG. 20 illustrates a perspective view of another exemplary fluid transfer system 185 according to one of various embodiments of the invention. An exemplary wall 186 is an outside wall of a building. Fluid transfer system 185 is a free standing structure that is not secured to or supported upon outside wall 186. A water spigot 188 extends outwardly from wall 186. Fluid transfer system 185 includes housing 190 which includes handles 191 and spout 192. It should be understood that housing 190 will have all the previously described structures such as valve systems even though not shown. Housing 190 is supported on a stand having legs 193, a cross bar 196 and stabilizer bars 195. Legs 193 terminate into caster wheels to provide mobility to the stand and Housing 190. Sink 197 has a curved portion 198 and drain opening 202 secured to a hose 199 for fluid evacuation to the environment 187 or ground, or a bush 200. Sink 197 is moved along direction arrow 201 to place curved portion 198 over cross bar 196 thereby securing sink 197 under spout 192 of housing 190. A water hose 189 is secured to spigot 188 and connected directly or indirectly to housing 190 to provide fluid communication with spout 192. An indirect connection would include the valve system (not shown) behind housing 190 as having conduits (not shown) as described in previous embodiments, and hose 189 being coupled to the conduit. Alternatively, the not shown conduit could be directly connected to spigot 188 to provide water to spout 192. It should be understood that all structures and method steps discussed with regard to fluid transfer system 185 are applicable to any and all fluid transfer systems disclosed in this document.

FIG. 21 illustrates a perspective view of another exemplary fluid transfer system 255 according to one of various embodiments of the invention. An exemplary wall 256 is an outside wall of a building and extends from ground 257. Fluid transfer system 255 is a free standing structure that is not secured to or supported upon outside wall 256. Moreover, fluid transfer system 255 is a unitary integral structure having a sink 264 and faucet 260 combination. Faucet 260 includes handles 261 and spout 262. Sink 264 has a large volume to receive water and waste and is comparable to a utility sink. In one embodiment, spout 262 is capable of swiveling horizontally. A water spigot 258 extends outwardly from wall 256. It should be understood that faucet 260 will have all the previously described structures such as valve systems even though not shown. Of course, any structure not needed could be removed before fluid transfer system 255 is moved outside for use. Fluid transfer system 255 is supported on a plurality of legs 263, for example, four legs 263. Sink 264 has a drain opening not shown and secured to a hose 265 for fluid evacuation to the environment or a bush 286. A water hose 259 is secured to spigot 258 and connected directly or indirectly to faucet 260 to provide fluid communication with spout 262. An indirect connection would include the valve system (not shown) behind faucet 260 as having conduits (not shown) as described in previous embodiments, and hose 259 is coupled to the conduit. Alternatively, the not shown conduit could be directly connected to spigot 258 to provide water to spout 262. It should be understood that all structures and method steps discussed with regard to fluid transfer system 255 are applicable to any and all fluid transfer systems disclosed in this document.

It should be understood that any inventive fluid transfer system disclosed in this document can be secured to any surface or wall, either outside or inside of a building, with an attachment device that supports the housing to the surface or wall. Exemplary attachment devices include an integral portion of a housing, a separate and discrete structure from the housing, an adhesive, a screw and/or any combination of these exemplary attachment devices.

It should be understood that any inventive fluid transfer system disclosed in this document, the following described inventive methods of forming the inventive fluid transfer system in a building is applicable. At a location other than the site of the building, connect a faucet to a housing structure. Transport the housing structure with the faucet to the site of the building. Place the faucet and housing structure in a space of the building. Connect the faucet in fluid communication with a water source of the building. It should be understood that the housing structure includes physical configurations and appearance characteristics, and before the transporting, modifying at least one of the physical configurations and appearance characteristics of the housing structure.

Still further, it should be understood that the inventive method of forming the inventive fluid transfer system includes planning the space of the building to have selected physical configurations and appearance characteristics upon completion. Moreover, it should be understood that the inventive method includes modifying at least one of the physical configurations and appearance characteristics of the housing structure based on at least one of the physical configurations and appearance characteristics planned for the space. Furthermore, it should be understood that the inventive method includes the modifying occurring before construction of the building. Additionally, it should be understood that the inventive method includes wherein the modifying occurs during the construction of the building. In addition, it should be understood that the inventive method includes wherein the modifying occurs after the construction of the building. In another aspect, it should be understood that the inventive method includes integrating the housing structure and faucet with the space. Still in another aspect, it should be understood that the inventive method includes wherein the placing comprises orienting the faucet relative a sink.

Furthermore, it should be understood that the inventive method of forming the inventive fluid transfer system includes wherein after the connecting, disconnecting the faucet from the water source of the building. Remove the housing structure and the faucet from the space. Move the housing structure and the faucet outside the building. Connect the faucet in fluid communication with a water source located outside of the building. It should be understood that the inventive method further includes providing a stand. Supporting the housing structure and faucet on the stand. Hanging the housing structure and faucet on an outer wall of the building. Orienting the housing structure and faucet operatively proximate a sink. In one exemplary inventive embodiment, the moving includes moving the housing structure and the faucet as a single unit. In another exemplary embodiment, the moving includes moving the housing structure and the faucet as separate units.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A fluid transfer system, the system comprising:
a fluid regulator comprising a valve and a tube in fluid communication with the valve;
a housing supporting the fluid regulator and comprising at least a partial enclosure, at least a portion of the fluid regulator in the enclosure, the tube extending through a first surface of the housing; and
a flexible conduit in fluid communication with the fluid regulator, the flexible conduit is compatible for connection with a fluid source.

2. The system of claim 1 further comprising an attachment device to support the housing to a surface.

3. The system of claim 2 wherein the attachment device comprises an integral portion of the housing.

4. The system of claim 2 wherein the attachment device comprises at least one of an integral portion of the housing, a separate and discrete structure from the housing, an adhesive and a screw, and any combination of these attachment devices.

5. The system of claim 1 wherein the housing comprises a mirror.

6. The system of claim 1 wherein the housing comprises a medicine cabinet.

7. A method of forming a fluid transfer system in a building, the method comprising:
at a location other than the site of the building, connecting a faucet to a housing structure;
transporting the housing structure with the faucet to the site of the building;
placing the faucet and housing structure in a space of the building; and
connecting the faucet in fluid communication with a water source of the building.

8. The method of claim 7 wherein the housing structure comprises physical configurations and appearance characteristics, and before the transporting, modifying at least one of the physical configurations and appearance characteristics of the housing structure.

9. The method of claim 7 wherein the housing structure comprises physical configurations and appearance characteristics, and further comprising:
planning the space of the building to have selected physical configurations and appearance characteristics upon completion; and
modifying at least one of the physical configurations and appearance characteristics of the housing structure based on at least one of the physical configurations and appearance characteristics planned for the space.

10. The method of claim 9 wherein the modifying occurs before construction of the building.

11. The method of claim 9 wherein the modifying occurs during the construction of the building.

12. The method of claim 9 wherein the modifying occurs after the construction of the building.

13. The method of claim 7 further comprising integrating the housing structure and faucet with the space.

14. The method of claim 7 wherein the placing comprises orienting the faucet relative a sink.

15. The method of claim 7 wherein after the connecting, further comprising:
disconnecting the faucet from the water source of the building;
removing the housing structure and the faucet from the space;
moving the housing structure and the faucet outside the building; and
connecting the faucet in fluid communication with a water source located outside of the building.

16. The method of claim 15 further comprising:
providing a stand; and
supporting the housing structure and faucet on the stand.

17. The method of claim 15 further comprising hanging the housing structure and faucet on an outer wall of the building.

18. The method of claim 15 further comprising orienting the housing structure and faucet operatively proximate a sink.

19. The method of claim 15 wherein the moving comprises moving the housing structure and the faucet as a single unit.

20. The method of claim 15 wherein the moving comprises moving the housing structure and the faucet as separate units.
